(19) United States
(12) Patent Application Publication
(10) Pub. No.: US 2018/0012556 A1
(43) Pub. Date: Jan. 11, 2018

(54) DISPLAY PANEL CONTROL METHOD AND DRIVING CIRCUIT THEREOF

(71) Applicant: AU OPTRONICS CORPORATION, Hsin-chu (TW)

(72) Inventors: Chih-Che HSU, Hsin-chu (TW); Shung-Ting TSAI, Hsin-chu (TW)

(21) Appl. No.: 15/641,733

(22) Filed: Jul. 5, 2017

(30) Foreign Application Priority Data
Jul. 7, 2016 (TW) 105121658

(51) Int. Cl. G09G 3/36

(52) U.S. Cl. CPC G09G 3/3688; G09G 3/3677; G09G 2310/08; G09G 2300/0426; G09G 2320/0247; G09G 2310/061

(57) ABSTRACT

A display panel control method for a display panel. The display panel includes at least one common electrode line and a plurality of data lines. The method provides a timing control signal including an active interval and a vertical blanking interval. The timing control signal is used to make the display panel either enter the active interval or enter the vertical blanking interval to execute corresponding operation procedures. When the display panel is in the active interval, the method provides corresponding data voltage to every data line according to the image data. When the display panel is in the vertical blanking interval, the method provides a blanking data voltage to every data line. The blanking data voltage is determined according to the polarity of the corresponding data voltage of the corresponding data line and a common voltage of the at least one common electrode line.

### CROSS-REFERENCE TO RELATED PATENT APPLICATION

This application claims the benefit of priority to Taiwan Patent Application No. 105121658, filed Jul. 7, 2016. The entire content of the above identified application is incorporated herein by reference.

Some references, which may include patents, patent applications and various publications, are cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD

The present disclosure relates to a display panel control method and a driving circuit thereof, and more particularly, to a display panel control method for controlling a display panel having a display frame that has a vertical blanking interval, and a driving circuit thereof.

### BACKGROUND

The background description provided herein is for the purpose of generally presenting the context of the present disclosure. Work of the presently named inventors, to the extent it is described in this background section, as well as aspects of the description that may not otherwise qualify as prior art at the time of filing, are neither expressly nor impliedly admitted as prior art against the present disclosure.

Although display quality is not perfect yet, liquid crystal displayer (LCD) is popular in the current consumer market due to various convenient features thereof. To be simple, an LCD selectively charges and discharges pixel units in a pixel array through gate lines and data lines, so as to display a display image that the LCD intends to display. The display image is updated in a fixed or changing frequency. Correspondingly, the data lines transmit data signals to be written into the pixel units, a plurality of frames are defined in the data signals, and each frame includes a piece of image data of a display image. While image data of the different frames being written into the pixel units, the pixel array updates the display image with time.

Generally, image data does not fill the whole corresponding frame, and therefore, the frame can be divided into an active interval and a vertical blanking interval according to the time. That is, the image data is written into a pixel unit in the active interval, and the pixel unit maintains, in the vertical blanking interval, a pixel voltage for a state that the image data is written into the pixel unit. In a preferable design, the pixel unit maintains the pixel voltage in the vertical blanking interval. However, the pixel voltage is subject to a coupling effect with a data line, and therefore is deviated, causing flicker. On the other hand, in order to avoid polarization of liquid crystals, in operation, polarity reversal is performed on operation voltages of the liquid crystals, further worsening the flicker of the display. Besides, with the evolution of display specifications, a coupling effect between a pixel voltage and a data line becomes inevitable, and becomes a significant subject in display design.

### SUMMARY

One aspect of the present disclosure provides a display panel control method and a driving circuit thereof, so as to improve a flicker problem of the display panel.

One aspect of the present disclosure discloses a display panel control method adapted to a display panel. The display panel has at least one common electrode line and a plurality of data lines. The method includes: providing a timing control signal, including an active interval and a vertical blanking interval, and configured to control the display panel in the active interval or in the vertical blanking interval to execute corresponding operation procedures; providing, when the display panel is in the active interval, a corresponding data voltage to each of the plurality of data lines according to image data; and providing, when the display panel is in the vertical blanking interval, a blanking data voltage to each of the plurality of data lines, where each blanking data voltage of the plurality of data lines is determined according to a polarity of the data voltage of the corresponding data line and a common voltage of the common electrode line.

One aspect of the present disclosure discloses a driving circuit, adapted to drive a display panel. The display panel has a plurality of data lines and at least one common electrode line. The driving circuit has a blanking interval detector, a source driver, and a first multiplexer. The source driver is electrically connected to the data lines. The first multiplexer is electrically connected to the source driver and the blanking interval detector. The blanking interval detector is configured to generate a selection signal, where the selection signal is configured to indicate an active interval or a vertical blanking interval. The first multiplexer is configured to control, according to the selection signal, the source driver to selectively provide a data voltage or a blanking data voltage to the source driver.

To sum up, the present disclosure provides a display panel control method and a driving circuit thereof, which provide different voltages to a data line in the active interval and the vertical blanking interval, so as to improve flicker phenomenon of a display panel. The voltage provided to the data line in the active interval is determined by a data voltage of a display image, and the voltage provided to the data line in the vertical blanking interval is determined at least according to a common voltage of the common electrode line. In this way, the display image regularly changes in the vertical blanking interval.

These and other aspects of the present disclosure will become apparent from the following description of the preferred embodiment taken in conjunction with the following drawings, although variations and modifications therein may be effected without departing from the spirit and scope of the novel concepts of the present disclosure.

### BRIEF DESCRIPTION OF THE DRAWINGS

The accompanying drawings illustrate one or more embodiments of the present disclosure and together with the written description, serve to explain the principles of the present disclosure. Wherever possible, the same reference numbers are used throughout the drawings to refer to the same or like elements of an embodiment, and wherein:

FIG. 1 is a schematic diagram of a display panel according to an embodiment of the present disclosure;

FIG. 2 is an equivalent circuit diagram of a pixel unit in FIG. 1 according to the present disclosure;

FIG. 3 is a schematic timing diagram of control signals of a display panel according to a comparative embodiment of the present disclosure;

FIG. 4A is a schematic diagram of a direction of charge transfer caused by capacitive coupling between pixel units and data lines under control timing of FIG. 3;

FIG. 4B is a schematic diagram of another direction of charge transfer caused by the capacitive coupling between the pixel units and the data lines under the control timing of FIG. 3;

FIG. 5 is a flowchart of a display panel control method according to an embodiment of the present disclosure;

FIG. 6 is a schematic timing diagram of control signals of a display panel according to an embodiment of a display panel control method of the present disclosure;

FIG. 7A is a schematic diagram of a direction of charge transfer caused by capacitive coupling between pixel units and data lines under control timing of FIG. 6;

FIG. 7B is a schematic diagram of another direction of charge transfer caused by the capacitive coupling between the pixel units and the data lines under the control timing of FIG. 6;

FIG. 8 is a schematic timing diagram of control signals of a display panel according to another embodiment of a display panel control method of the present disclosure;

FIG. 9 is a schematic functional block diagram of a driving circuit according to an embodiment of the present disclosure;

FIG. 10 is a schematic functional block diagram of a driving circuit according to another embodiment of the present disclosure; and

FIG. 11 is a schematic diagram of voltage levels illustrated according to data reference voltage sources and blanking reference voltage sources in FIG. 10.

### DETAILED DESCRIPTION

The present disclosure will now be described more fully hereinafter with reference to the accompanying drawings, in which exemplary embodiments of the invention are shown. This present application may, however, be embodied in many different forms and should not be construed as limited to the embodiments set forth herein. Rather, these embodiments are provided so that the present disclosure will be thorough and complete, and will fully convey the scope of the invention to those skilled in the art. Like reference numerals refer to like elements throughout.

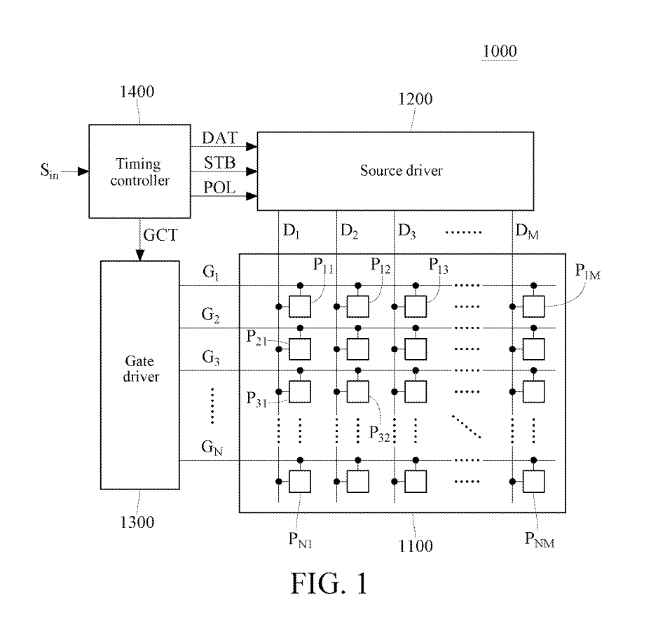

Referring to FIG. 1, FIG. 1 is a schematic diagram of a display panel according to an embodiment of the present disclosure. As shown in FIG. 1, a display panel 1000 has a display module 1100, a source driver 1200, a gate driver 1300, and a timing controller 1400. The display module 1100 is electrically connected to the source driver 1200 and the gate driver 1300, and the timing controller 1400 is electrically connected to the source driver 1200 and the gate driver 1300. Further, the display module 1100 has a plurality of data lines D₁-D_{M}, a plurality of gate lines G₁-G_{N}, and a plurality of pixel units P₁₁-P_{NM}. Each of the pixel units P₁₁-P_{NM} is electrically connected to one of the data lines D₁-D_{M} and one of the gate lines G₁-G_{N}. A first subscript of a reference sign of a pixel unit represents a row, and a second subscript represents a column, for example, the pixel unit P₃₂ represents that the pixel unit is located at the third row and the second column. The pixel units P₁₁-P_{NM} are controlled by the source driver 1200 through the data lines D₁-D_{M} to which the pixel units are electrically connected, and the pixel units P₁₁-P_{NM} are controlled by the gate driver 1300 through the gate lines G₁-G_{N} to which the pixel units are electrically connected, where N and M are positive integers. The timing controller 1400 is configured to provide, according to an input signal Sᵢₙ, a corresponding data signal DAT, a start signal STB, or a polarity signal POL to the source driver 1200. The timing controller 1400 is further configured to provide, according to the input signal Sᵢₙ, a corresponding gate control signal GCT to the gate driver 1300, so as to enable the source driver 1200 and the gate driver 1300 to operate normally. Relevant details are known to a person of ordinary skill in the art, and are not described herein.

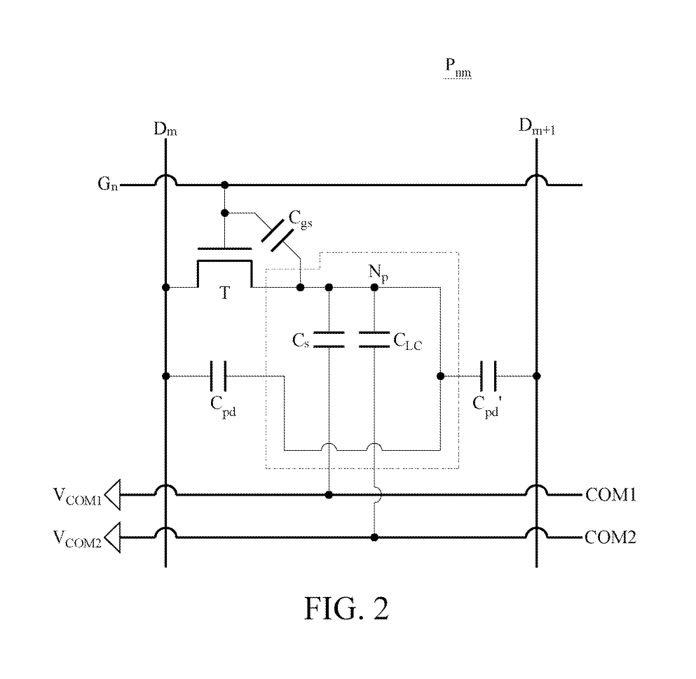

Referring to FIG. 2, FIG. 2 is an equivalent circuit diagram of a pixel unit in FIG. 1 according to the present disclosure. In FIG. 2, a pixel unit Pₙₘ is used as an example for description, where n is a positive integer less than N, m is a positive integer less than M, n represents that the pixel unit Pₙₘ is located at the nth row, and m represents that the pixel unit Pnm is located at the mth column. As shown in FIG. 2, an equivalent circuit of the pixel unit Pₙₘ has a thin film transistor (TFT) T, a storage capacitor C_{S}, and a liquid crystal capacitor C_{LC}. A first terminal of the TFT T is electrically connected to a data line Dₘ, a second terminal of the TFT T is electrically connected to one end of the storage capacitor C_{S} and one end of the liquid crystal capacitor C_{LC}, and a control terminal of the TFT T is electrically connected to a gate line Gₙ. As described earlier, one end of the storage capacitor C_{S} and one end of the liquid crystal capacitor C_{LC} are electrically connected to the second terminal of the TFT T, the other end of the storage capacitor C_{S} is electrically connected to a first common electrode line COM1, so as to receive a first common voltage V_{COM1}, and the other end of the liquid crystal capacitor C_{LC} is electrically connected to a second common electrode line COM2, so as to receive a second common voltage V_{COM2}. In an embodiment, a first common electrode line COM1 is electrically connected to a common electrode layer of an active element array, for example, and a second common electrode line COM2 is electrically connected to a common electrode layer of an opposite substrate or a color filter substrate, but the present disclosure is not limited thereto. In practice, the first common voltage V_{COM1} and the second common voltage V_{COM2} may be the same, or may be different, and the description below is made by using an example that the first common voltage V_{COM1} and the second common voltage V_{COM2} are the same.

The TFT T is selectively conducted according to a voltage level of the gate line Gₙ. When the TFT T is conducted, the storage capacitor C_{S} and the liquid crystal capacitor C_{LC} are coupled to the data line Dₘ, and therefore, at this time, a data signal on the data line Dₘ is written into the storage capacitor C_{S} and the liquid crystal capacitor C_{LC}, so as to selectively charge a capacitor electrode or a pixel electrode in the pixel unit Pₙₘ according to the data signal. From another perspective, the gate driver 1300 sequentially provides, through the gate lines G₁-G_{N}, scan signals to the rows of pixel units P₁₁-P_{NM}, so as to sequentially conduct the TFTs of the pixel units P₁₁-P_{NM} in the rows of pixel units P₁₁-P_{NM}. When the TFTs are conducted, the capacitor electrodes or pixel electrodes in the pixel units P₁₁-P_{NM} are selectively charged according to the data signals on the data lines D₁-D_{M} to which the pixel units P₁₁-P_{NM} are electrically connected.

Besides, the equivalent circuit of the pixel unit Pₙₘ further has capacitors C_{gs}, C_{pd}, and C_{pd}′. The capacitor C_{gs} is a parasitic capacitor between the control terminal and the second terminal of the TFT T, the capacitor C_{pd} is a coupling capacitor between the pixel electrode the data line Dₘ, and the capacitor C_{pd}′ is a coupling capacitor between the pixel electrode and the data line Dₘ₊₁. Therefore, equivalently, in addition to that the storage capacitor C_{S} and the liquid crystal capacitor C_{LC} are respectively coupled to the first common voltage V_{COM1} and the second common voltage V_{COM2}, potentials stored in the storage capacitor C_{S} and the liquid crystal capacitor C_{LC} are easily affected by data voltages of the data lines Dₘ and Dₘ₊₁. In other words, voltage levels of the data lines Dₘ and Dₘ₊₁ affect, through the coupling capacitors C_{pd} and C_{pd}′, electric energy stored in the storage capacitor C_{S} and the liquid crystal capacitor C_{LC}, so as to affect cross voltages of the storage capacitor C_{S} and the liquid crystal capacitor C_{LC}, and further affect a display image provided by the display panel 1000. In an embodiment, polarities of the voltages of the data lines Dₘ and Dₘ₊₁ are opposite, and the opposite polarities herein are defined relative to the second common voltage V_{COM2}. The definition and the meaning thereof are known to a person of ordinary skill in the art, and details are not described herein. The subsequent embodiments are described by using like embodiments, and the feature is not further explained.

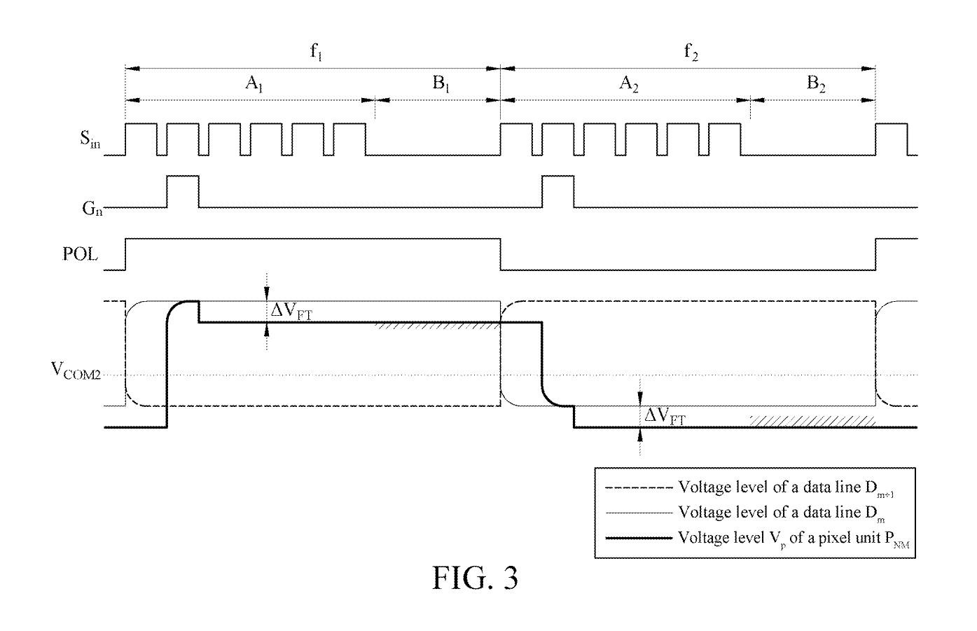

Referring to FIG. 1 to FIG. 3, how the data lines Dₘ and Dₘ₊₁ affect the electric energy stored in the storage capacitor C_{S} and the liquid crystal capacitor C_{LC} is described, and FIG. 3 is a schematic timing diagram of control signals of a display panel according to a comparative embodiment of the present disclosure. In order to achieve conciseness of description, it is defined that a node Nₚ in FIG. 2 has a voltage level Vₚ. As shown in FIG. 3, every frame f₁, f₂ interval includes an active interval A₁, A₂ (vertical active interval) and a vertical blanking interval B₁, B₂ (vertical blanking interval). In an active interval, the input signal Sᵢₙ bears relevant data to be displayed, and the voltage level of the input signal Sᵢₙ changes, so as to instruct the display panel 1000 to update the display image. Moreover, in a vertical blanking interval, the input signal Sᵢₙ does not need to instruct the display panel 1000 to update the display image, and therefore, the input signal Sᵢₙ is of a low voltage level.

In the frame f₁, the polarity signal POL is of a high voltage level, and therefore, the source driver 1200 provides a positive data voltage to the data line Dₘ and provides a negative data voltage to the data line Dₘ₊₁. However, in the frame f₂, the polarity signal POL is of a low voltage level, and therefore, the source driver 1200 provides a negative data voltage to the data line Dₘ and provides a positive data voltage to the data line Dₘ₊₁. When a voltage level of the gate line Gₙ is of a high voltage level, the data voltage of the data line Dₘ is written into the pixel unit Pₙₘ, and therefore, the voltage level Vₚ of the node Nₚ is pulled up to the high voltage level. Ideally, the voltage level Vₚ of the node Nₚ maintains the high voltage level in the frame f₁. However, when the voltage level of the gate line Gₙ changes from the high voltage level to a low voltage level, the voltage level Vₚ is reduced by a feed through voltage difference ΔV_{FT} due to an impact of instantaneous close of the TFT T. The feed through voltage difference ΔV_{FT} is related to a feed through effect. The feed through effect is known to a person of ordinary skill in the art, and details are not described herein.

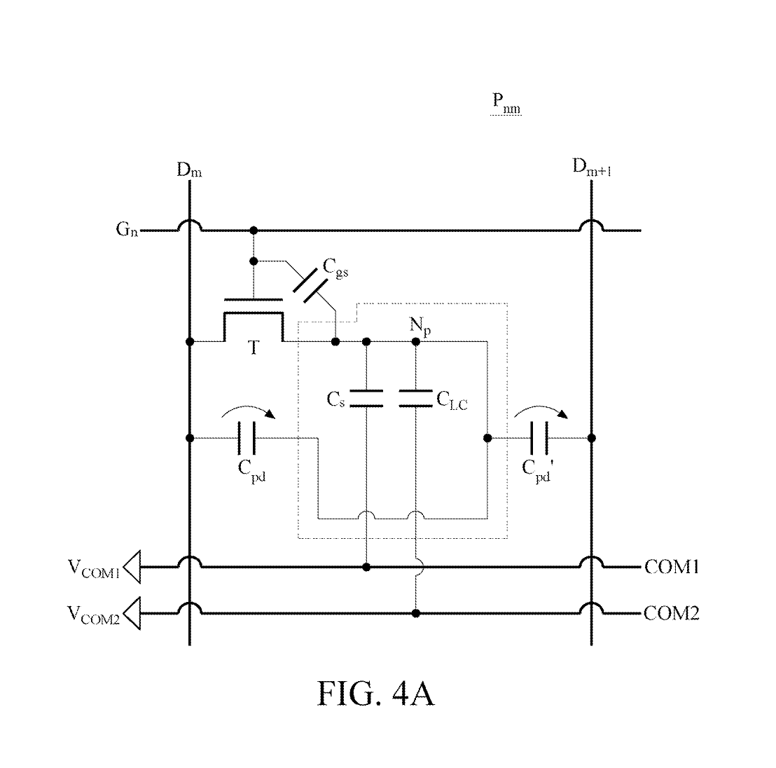

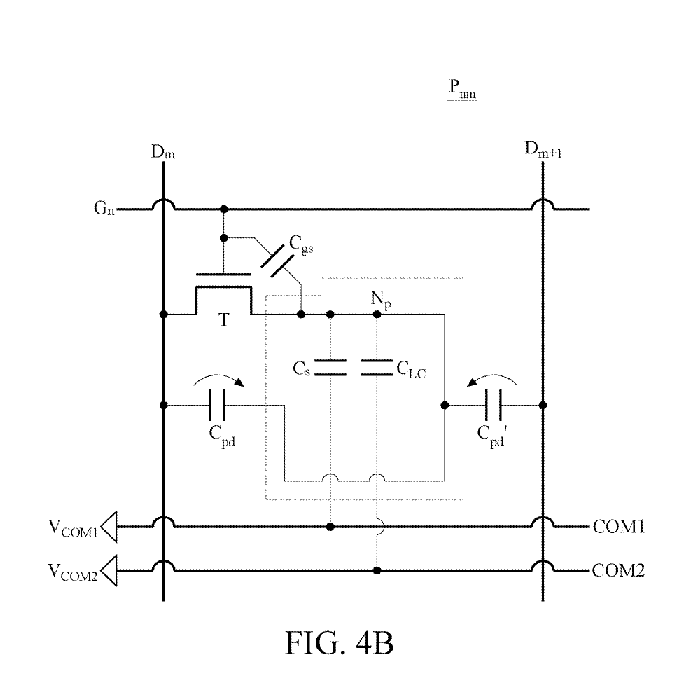

Besides, in the vertical blanking interval B₁, the voltage level Vₚ changes due to impacts of the coupling capacitors C_{pd}, C_{pd}′. Description is made by referring to FIG. 4A and FIG. 4B, FIG. 4A is a schematic diagram of a direction of charge transfer caused by capacitive coupling between pixel units and data lines under control timing of FIG. 3, and FIG. 4B is a schematic diagram of another direction of charge transfer caused by the capacitive coupling between the pixel units and the data lines under the control timing of FIG. 3. As shown in the figures, in the vertical blanking interval B₁, the data line Dₘ pulls up the voltage level of the node Nₚ through the capacitor C_{pd}, and the data line Dₘ₊₁ pulls down the voltage level of the node Nₚ through the capacitor C_{pd}′, as shown in FIG. 4A. However, in the frame f₂, polarities of the voltage levels of the data lines Dₘ and Dm+1 are reversed, and therefore, in the vertical blanking interval B₂, the data line Dₘ pulls up the voltage level of the node Nₚ through the capacitor C_{pd}, and the data line Dₘ₊₁ pulls up the voltage level of the node Nₚ through the capacitor C_{pd}′, as shown in FIG. 4B. In other words, with a conventional control manner, in the vertical blanking intervals of adjacent frames, coupling effects between the pixel unit Pₙₘ and the capacitors C_{pd} and C_{pd}′ are not the same, so that changes of the voltage level Vₚ are not fixed, and consequently, the display image is subject to an unexpected change of brightness, which is hardly compensated and corrected.

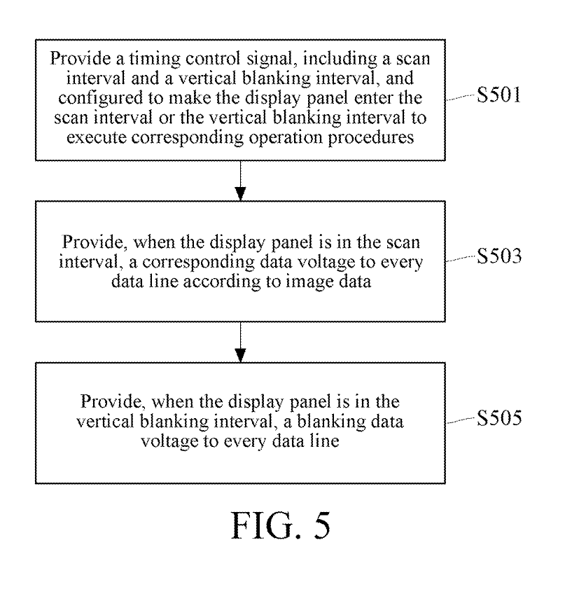

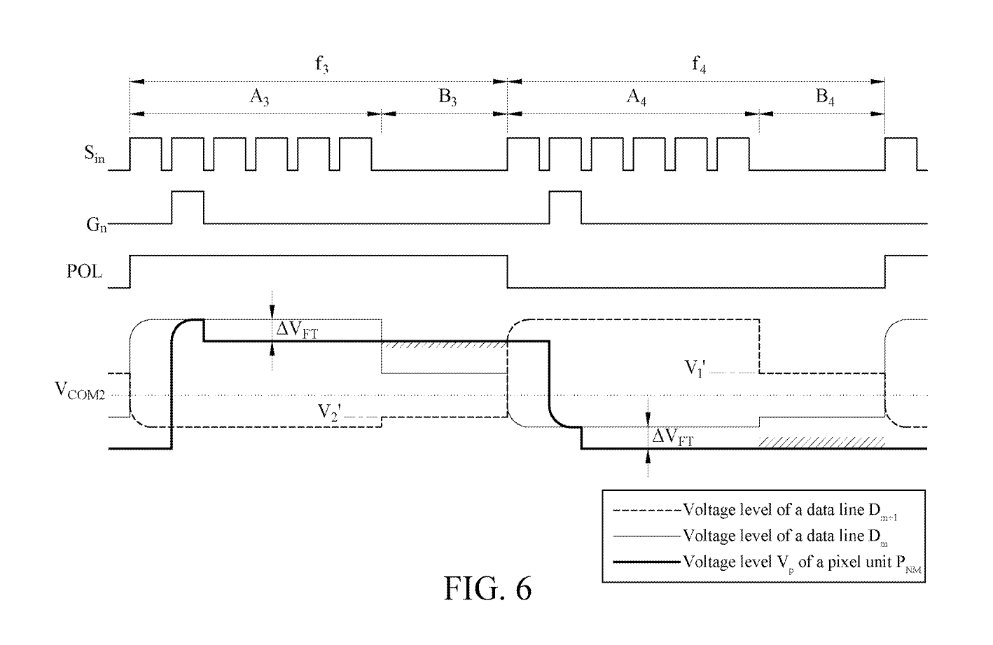

In view of that, the present disclosure provides a display panel control method. Description is made by referring to FIG. 5, and FIG. 5 is a flowchart of a display panel control method according to an embodiment of the present disclosure. The display panel control method provided in the present disclosure is adapted to control a display panel. The display panel has a plurality of data lines and one common electrode line, where polarities of two adjacent data lines in the data lines are reverse. Step S501 provides a timing control signal, including an active interval and a vertical blanking interval, and configured to make the display panel enter the active interval or the vertical blanking interval to execute corresponding operation procedures. Step S503 provides that when the display panel is in the active interval, a corresponding data voltage to every data line according to image data. Step S505 provides that when the display panel is in the vertical blanking interval, a blanking data voltage to every data line. Every blanking data voltage is determined according to a polarity of the data voltage of the corresponding data line and a common voltage of the common electrode line. Further description is made by referring to FIG. 6, and FIG. 6 is a schematic timing diagram of control signals of a display panel according to an embodiment of a display panel control method of the present disclosure. Different from the foregoing comparative embodiment, in the embodiments corresponding to FIG. 5 and FIG. 6, at a frame f₃ interval, a voltage level of a data line Dₘ is adjusted to a positive blanking data voltage V₁′ in a vertical blanking interval B₃, and a voltage level of a data line Dₘ₊₁ is adjusted to a negative blanking data voltage V₂′ in the vertical blanking interval B₃. The positive blanking data voltage V₁′ and the negative blanking data voltage V₂′ are determined according to a second common voltage V_{COM2} of a second common electrode line COM2. However, in a vertical blanking interval B₄ of a frame f₄ interval, due to polarity reversal, the voltage level of the data line Dₘ is adjusted to the negative blanking data voltage V₂′, and the voltage level of the data line Dₘ₊₁ is adjusted to the positive blanking data voltage V₁′.

In an embodiment, the positive blanking data voltage V₁′ and the negative blanking data voltage V₂′ are symmetrical relative to the second common voltage V_{COM2}. More specifically, an absolute value of a difference between the positive blanking data voltage V₁′ and the second common voltage V_{COM2} is the same as an absolute value of a difference between the negative blanking data voltage V₂′ and the second common voltage V_{COM2}. From another perspective, the second common voltage V_{COM2} is approximately equal to an average value of the positive blanking data voltage V₁′ and the negative blanking data voltage V₂′. In another embodiment, a positive blanking data voltage V₁′ and a negative blanking data voltage V₂′ are further slightly adjusted according to a second common voltage V_{COM2} and capacitors C_{pd} and C_{pd}′.

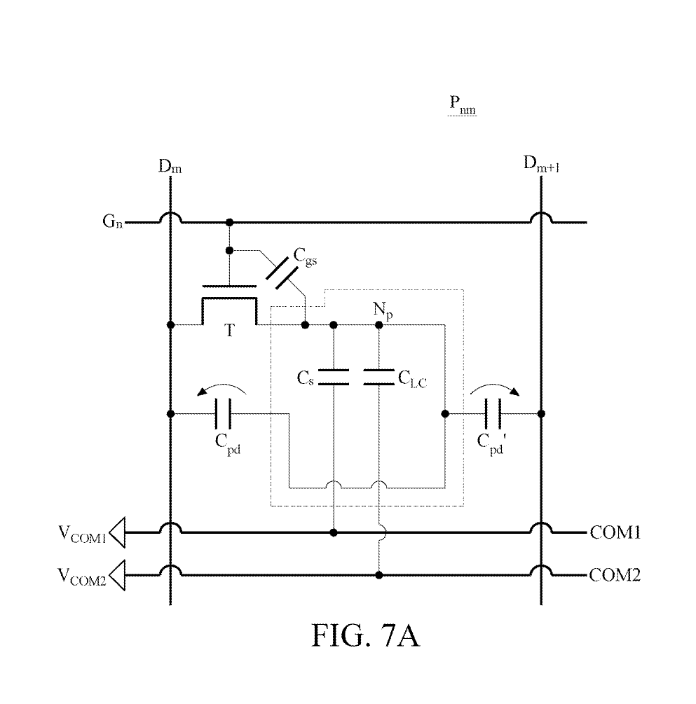

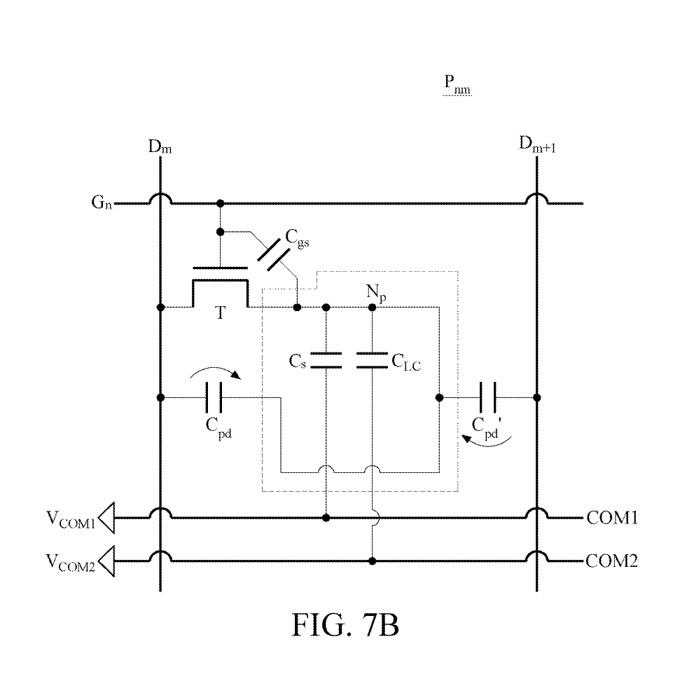

Referring to FIG. 7A and FIG. 7B together, FIG. 7A is a schematic diagram of a direction of charge transfer caused by capacitive coupling between pixel units and data lines under control timing of FIG. 6, and FIG. 7B is a schematic diagram of another direction of charge transfer caused by the capacitive coupling between the pixel units and the data lines under the control timing of FIG. 6. As shown in FIG. 6 and FIG. 7A, in a frame f₃ interval, when the pixel unit Pₙₘ is driven by a positive driving signal, in the corresponding vertical blanking interval, the voltage level of the node Nₚ is pulled down by the data lines Dₘ, Dₘ₊₁, and the voltage level Vₚ gets close to the second common voltage V_{COM2}. As shown in FIG. 6 and FIG. 7B, at a frame f₄ interval, when the pixel unit Pₙₘ is driven by a negative driving signal, in the corresponding vertical blanking interval, the voltage level of the node Nₚ is pulled up by the data lines Dₘ, Dₘ₊₁, and the voltage level Vₚ also gets close to the second common voltage V_{COM2}. Therefore, even the pixel unit Pₙₘ is driven by signals of different polarities in the vertical blanking intervals of different frames, the voltage level Vₚ gets close to the second common voltage V_{COM2}, so that light emitted by the pixel unit Pₙₘ in the vertical blanking intervals of different frames becomes dimmer or brighter. For example, when twisted nematic liquid crystal (TN) is used, a decreased voltage enables an image to become brighter, and when vertical alignment liquid crystal (VA) is used, a decreased voltage enables an image to become dimmer. However, no matter which type of liquid crystal is used, light emission of the pixel unit Pnm in the vertical blanking intervals becomes expectable, which alleviates a flicker problem of the image, and facilitates correction and compensation.

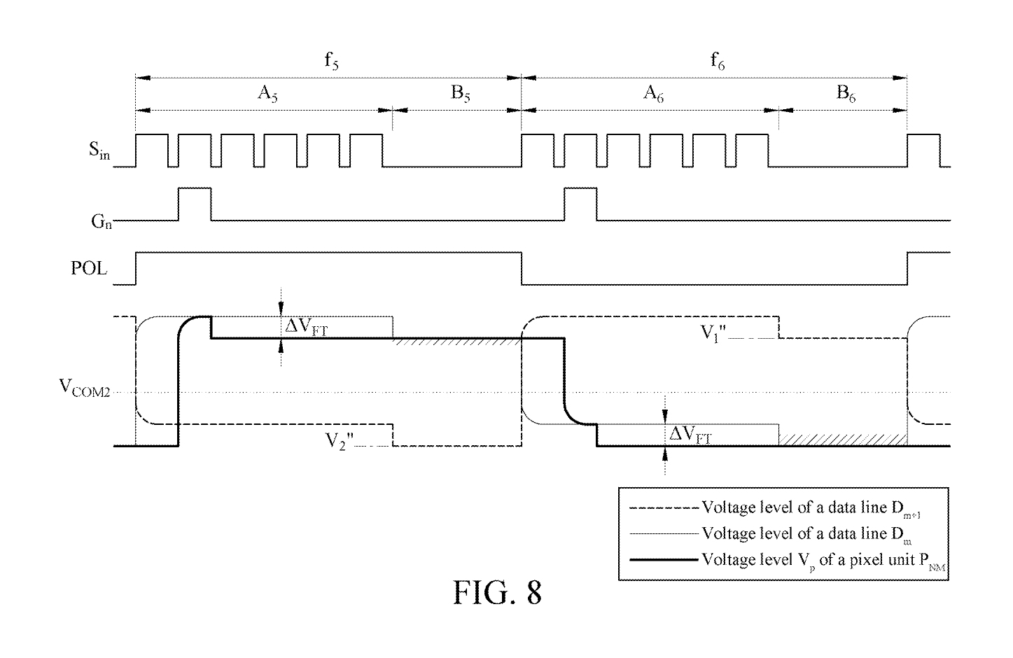

Further referring to FIG. 6, FIG. 7A, and FIG. 7B, in a variant embodiment of this embodiment, in a frame f₃ interval, a voltage level of a data line Dₘ is adjusted to a negative blanking data voltage V₂ in a vertical blanking interval B₃, and a voltage level of a data line Dₘ₊₁ is adjusted to a positive blanking data voltage V₁′ in the vertical blanking interval B₃. However, in a vertical blanking interval B₄ of a frame f₄ interval, due to polarity reversal, the voltage level of the data line Dₘ is adjusted to the positive blanking data voltage V₁′, and the voltage level of the data line Dₘ₊₁ is adjusted to the negative blanking data voltage V₂′. With regard to directions of charge transfer, as shown in FIG. 7A and FIG. 7B, in the vertical blanking interval of the frame f₃ interval, a voltage level of a node Nₚ is pulled down by the data lines Dₘ, Dₘ₊₁, and the voltage level Vₚ gets close to a second common voltage V_{COM2}; and in the vertical blanking interval of the frame f₄ interval, the data lines Dₘ, Dₘ₊₁ pulls up the voltage level of the node Nₚ, the voltage level Vₚ also gets close to the second common voltage V_{COM2}. This variant embodiment differs from the foregoing embodiment in that a time point for polarity reversal of a data signal is in a vertical blanking interval, for example, a time point for polarity reversal of a POL signal may be before the vertical blanking interval B₃. Further referring to FIG. 8, FIG. 8 is a schematic timing diagram of control signals of a display panel according to another embodiment of a display panel control method of the present disclosure. As shown in FIG. 8, in an active interval A₅, a voltage level Vₚ is first pulled up to a desired voltage value, and then is decreased by a feed through voltage difference ΔV_{FT} due to a feed through effect caused by instantaneous close of a TFT T. However, in a subsequent vertical blanking interval B₅, a voltage level of a data line Dₘ is pulled down to a positive blanking data voltage V₁″, and a voltage level of a data line Dₘ₊₁ is pulled down to a negative blanking data voltage V₂″. In this embodiment, the positive blanking data voltage V₁″ is set as the voltage level Vₚ in the active interval A₅ that is obtained after being affected by the feed through effect, and a voltage level of the negative blanking data voltage V₂″ and a voltage level of the positive blanking data voltage V₁″ are symmetrical relative to a second common voltage V_{COM2}. Therefore, in the vertical blanking interval B₅, the voltage level Vₚ gets close to the second common voltage V_{COM2}.

Similarly, in an active interval A₆, a voltage level Vₚ is first pulled down to a desired voltage value, and then is further decreased by a feed through voltage difference ΔV_{FT} due to a feed through effect caused by instantaneous close of the TFT T. However, in a subsequent vertical blanking interval B₆, the voltage level of the data line Dₘ is pulled down to the negative blanking data voltage V₂″, and the voltage level of the data line Dₘ₊₁ is pulled down to the positive blanking data voltage V₁″. In this embodiment, the negative blanking data voltage V₂″ is set as the voltage level Vₚ at the active interval A₆ that is obtained after being affected by the feed through effect, and the voltage level of the positive blanking data voltage V₁″ and the voltage level of the negative blanking data voltage V₂″ are symmetrical relative to the second common voltage V_{COM2}. Therefore, similar to the vertical blanking interval B₅, in the vertical blanking interval B₆, the voltage level Vₚ also gets close to the second common voltage V_{COM2}. Therefore, in the embodiment shown in FIG. 8, light emission of the pixel unit Pₙₘ in the vertical blanking intervals also becomes expectable, which alleviates a flicker problem of an image, and facilitates correction and compensation.

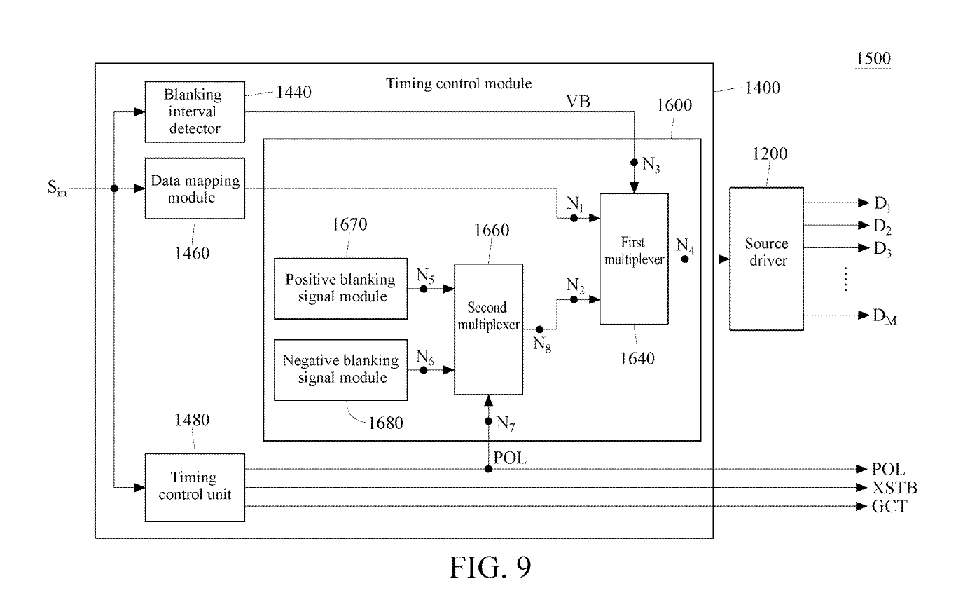

In continuation to the foregoing concepts, the present disclosure further provides a driving circuit. Description is made by referring to FIG. 9, and FIG. 9 is a schematic functional block diagram of a driving circuit according to an embodiment of the present disclosure. The driving circuit 1500 is adapted to drive a display panel 1000. The display panel 1000 has a plurality of data lines D₁-D_{M} and at least one common electrode line. The driving circuit 1500 includes a source driver 1200 and a timing control module 1400, and the timing control module 1400 is electrically connected to the source driver 1200. The timing control module 1400 includes a blanking drive control module 1600, a blanking interval detector 1440, a data mapping module 1460, and a timing control unit 1480. The blanking drive control module 1600 includes a first multiplexer 1640, a second multiplexer 1660, a positive blanking signal module 1670, and a negative blanking signal module 1680. The first multiplexer 1640 has a first input terminal N₁, a second input terminal N₂, a selection terminal N₃, and an output terminal N₄. The second multiplexer 1660 has a first input terminal N₅, a second input terminal N₆, a selection terminal N₇, and an output terminal N₈.

More specifically, the blanking interval detector 1440, the data mapping module 1460, and the timing control unit 1480 receive an input signal Sᵢₙ. The blanking interval detector 1440 is electrically connected to the selection terminal N₃ of the first multiplexer 1640 of the blanking drive control module 1600. The data mapping module 1460 is electrically connected to the first input terminal N₁ of the first multiplexer 1640. The second input terminal N₂ of the first multiplexer 1640 is electrically connected to the output terminal N₈ of the second multiplexer 1660. The first input terminal N₅ of the second multiplexer 1660 is coupled to the positive blanking drive signal module 1670, and the second input terminal N₆ is coupled to the negative blanking drive signal module 1680. The selection terminal N₇ of the second multiplexer 1660 is electrically connected to the timing control unit 1480, so as to receive a polarity signal POL.

The blanking interval detector 1440 is configured to detect, according to the input signal Sᵢₙ, whether a current time point is in the vertical blanking interval, and generate, on the basis of the foregoing detection, a selection signal V_{B} for the first multiplexer 1640. The data mapping module 1460 is configured to generate, according to the input signal Sᵢₙ, a data signal for the first multiplexer 1640. The timing control unit 1480 is configured to generate a polarity signal POL, a timing control signal GTC, and a start signal XSTB according to the input signal Sᵢₙ. The relevant details are known to a person of ordinary skill in the art, and are not described herein. When the selection signal V_{B} indicates an active interval, the first multiplexer 1640 is controlled by the selection signal V_{B} to output a data signal generated by the data mapping module 1460 to the source driver 1200. However, when the selection signal V_{B} indicates a vertical blanking interval, the first multiplexer 1640 is controlled by the selection signal V_{B} to output a positive blanking drive signal or a negative blanking drive signal to the source driver 1200.

The first input terminal N₅ of the second multiplexer 1660 is configured to receive a positive blanking signal of the positive blanking signal module 1670. The second input terminal N₆ is configured to receive a negative blanking signal of the negative blanking signal module 1680. The selection terminal N₇ is configured to receive the polarity signal POL. The output terminal N₈ is electrically connected to the second input terminal N₂ of the first multiplexer 1640. When the polarity signal POL indicates positive, the second multiplexer 1660 outputs the positive blanking drive signal to the first multiplexer 1640, and when the polarity signal POL indicates negative, the second multiplexer 1660 outputs the negative blanking drive signal to the first multiplexer 1640.

The source driver 1200 is electrically connected to the first multiplexer 1640, and is electrically connected to the data lines D₁-D_{M} so as to respectively output a plurality of data signals to the data lines D₁-D_{M}. When the selection signal V_{B} received by the first multiplexer 1640 indicates an active interval, the first multiplexer 1640 controls the source driver 1200 to provide a corresponding data voltage to every data line D₁-D_{M}. When the selection signal V_{B} received by the first multiplexer 1640 indicates a vertical blanking interval, the first multiplexer 1640 controls, according to the blanking drive signal, the source driver 1200 to provide a corresponding blanking data voltage to every data line D₁-D_{M}, for example, separately provide the foregoing positive blanking data voltages V_{1′}, V_{1″} or the foregoing negative blanking data voltages V_{2′}, V_{2″} to the data line Dm and the data line Dₘ₊₁ according to the corresponding polarities.

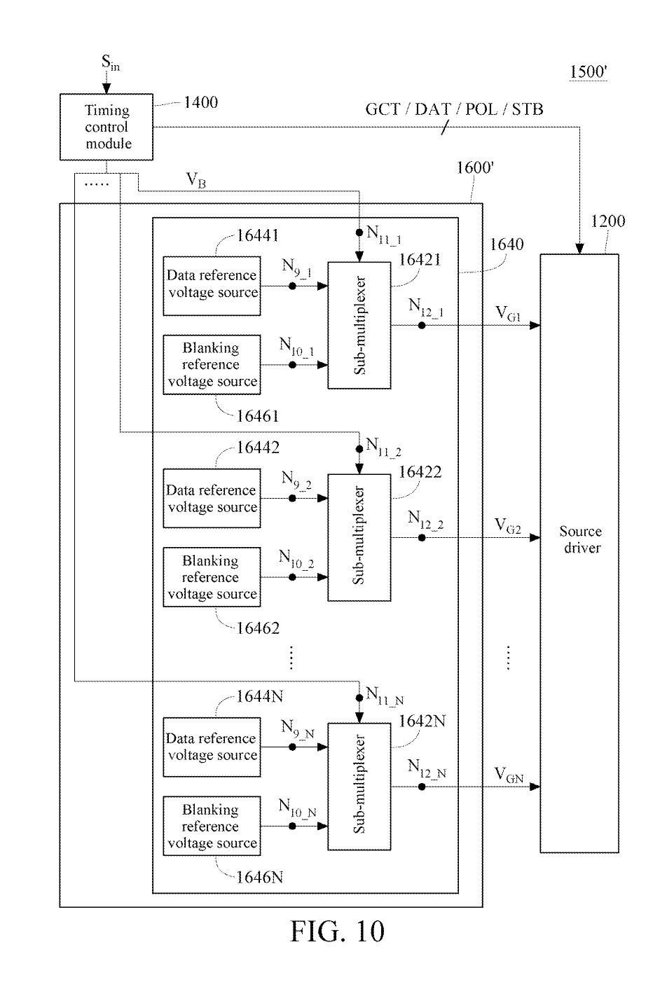

Further referring to FIG. 10, FIG. 10 is a schematic functional block diagram of a driving circuit according to another embodiment of the present disclosure. In the embodiment shown in FIG. 10, data reference voltage sources 16441-1644N may be a same voltage source or different voltage sources. Similarly, blanking reference voltage sources N10_1-N10_N may be a same voltage source or different voltage sources, and sub-multiplexers 16421-1642N may be replaced by a 2N−1 multiplexer. In order to achieve conciseness of description, the data reference voltage sources 16441-1644N, the blanking reference voltage sources N10_1-N10_N, and the sub-multiplexers 16421-1642N are used as examples for description, but in practice, the present disclosure is not limited to the figure.

In the embodiment of FIG. 10, a driving circuit 1600′ is separated from a timing controller 1400. A source driver 1200 converts data signals DAT into corresponding drive voltages according to polarity signals POL, and reference voltages V_{G1}-V_{GM} received from a first multiplexer 1640, and provides the drive voltages to pixel units P₁₁-P_{NM} through data lines D₁-D_{M}. The first multiplexer 1640 includes sub-multiplexers 16421-1642M, and each of the sub-multiplexers 16421-1642M includes a first input terminal N₉_{_}₁-N₉_{_}_{M}, a second input terminal N₁₀_{_}₁-N₁₀_{_}_{M}, a selection terminal N₁₁_{_}₁-N₁₁_{_}_{M}, and an output terminal N₁₂_{_}₁-N₁₂_{_}_{M}. Using the sub-multiplexer 16421 as an example, the first input terminal N₉_{_}₁ is electrically connected to the data reference voltage source 16441. The second input terminal N₁₀_{_}₁ is electrically connected to the blanking reference voltage source 16461. The selection terminal N₁₁_{_}₁ is configured to receive the selection signal V_{B}. The output terminal N₁₂_{_}₁ is electrically connected to the source driver 1200. When the selection signal V_{B} indicates an active interval, the first input terminal N₉_{_}₁ is electrically connected to the source driver 1200, that is, at this time, a data voltage generated by the data reference voltage source 16441 is provided to the source driver 1200 through the sub-multiplexer 16421. When the selection signal V_{B} indicates a vertical blanking interval, the second input terminal N₁₀_{_}₁ is electrically connected to the source driver 1200, that is, at this time, a positive blanking voltage or a negative blanking voltage generated by the blanking reference voltage source 16461 is provided to the source driver 1200 through the multiplexer 16421.

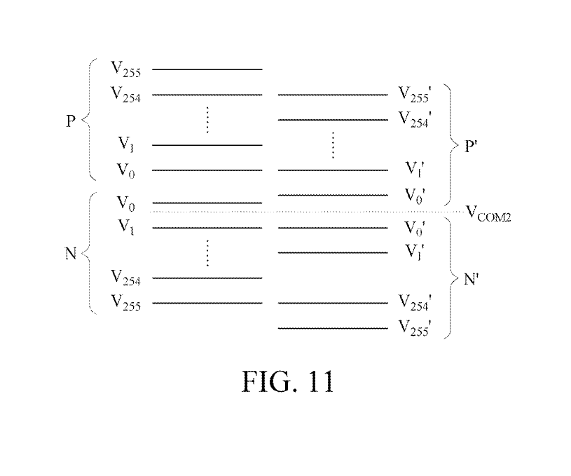

Referring to FIG. 11 for description of differences between the data reference voltage sources 16441-1644M and the blanking reference voltage sources 16461-1646M in FIG. 10, FIG. 11 is a schematic diagram of voltage levels illustrated according to data reference voltage sources and blanking reference voltage sources of FIG. 10. Using the data reference voltage source 16441 and the blanking reference voltage source 16461 as examples, output voltage values of the data reference voltage source 16441 may be classified into a positive group P and a negative group N as shown at a left side of FIG. 11, and each of the positive group P and the negative group N has 256 possible voltage values V₀-V₂₅₅. In the positive group P, the voltage value V₀ is less than the voltage value V₁, the voltage value V₁ is less than the voltage value V₂. In the negative group N, the voltage value V₂₅₅ is less than the voltage value V₂₅₄, the voltage value V₂₅₄ is less than the voltage level V₂₅₃. Output voltage values of the blanking reference voltage source 16461 may be classified into a positive group P′ and a negative group N′ at a right side of FIG. 11, and each of the positive group P′ and the negative group N′ also has 256 possible voltage values V_{0′}-V_{255′}. The value relationships between the voltage values V_{0′}-V_{255′} in different groups are similar to those of the voltage values V₀-V₂₅₅.

The difference between the voltage values V₀′-V₂₅₅′ and the voltage values V₀-V₂₅₅ is that the voltage values V₀′-V₂₅₅′ in the positive group P′ and the voltage values V₀′-V₂₅₅′ in the negative group N′ are symmetrical relative to a second common voltage V_{COM2}, and the voltage values V₀-V₂₅₅ in the positive group P and the voltage values V₀-V₂₅₅ of the negative group N are not necessarily symmetrical relative to the second common voltage V_{COM2}. More specifically, an absolute difference value between the voltage value V_{0′} in the positive group P′ and the second common voltage V_{COM2} is equal to an absolute difference value between the voltage value V₀′ in the negative group N′ and the second common voltage V_{COM2}. An absolute difference value between the voltage value V₁′ in the positive group P′ and the second common voltage V_{COM2} is equal to an absolute difference value between the voltage value V₁′ in the negative group N′ and the second common voltage V_{COM2}. Besides, in this embodiment, upon comparison, the voltage value V₀ in the positive group P is greater than the voltage value V_{0′} in the positive group P′ by one feed through voltage difference ΔV_{FT}, the voltage value V₀ in the negative group N is greater than the voltage value V₀′ in the negative group N′ by one feed through voltage difference ΔV_{FT}. Relationships between other voltage values V_{2′}-V_{255′} in different groups can be derived in accordance thereto, and details are not described herein again.

To sum up, the present disclosure provides a display panel control method and a driving circuit thereof, in which a corresponding data voltage is provided to every data line in an active interval according to image data. In a vertical blanking interval, a positive blanking data voltage is provided to one of two adjacent data lines, or a negative blanking data voltage is provided to the other data line of the two adjacent data lines. In this way, directions of charge transfer caused by capacitive coupling between pixel units and adjacent data lines are the same, so as to alleviate flicker of a display panel, and enable a display image in a vertical blanking interval to become predictable. A voltage provided to a data line in a vertical blanking interval is determined according to a common voltage of a common electrode line.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

What is claimed is:

1. A display panel driving method, adapted to a display panel that has a plurality of data lines and at least one common electrode line, the method comprising:
providing a timing control signal, comprising an active interval and a vertical blanking interval, and configured to control the display panel in the active interval or in the vertical blanking interval to execute corresponding operation procedures;
providing, when the display panel is in the active interval, a corresponding data voltage to each of the plurality of data lines according to image data; and
providing, when the display panel is in the vertical blanking interval, a blanking data voltage to each of the plurality of data lines, wherein
each blanking data voltage of the plurality of data lines is determined according to a polarity of the corresponding data voltage of every data line and a common voltage of the at least one common electrode line.

2. The method according to claim 1, wherein when the data voltage is positive, the blanking data voltage is a positive blanking data voltage; when the data voltage is negative, the blanking data voltage is a negative blanking data voltage; and an absolute difference value between the positive blanking data voltage and the common voltage is substantially equal to an absolute difference value between the negative blanking data voltage and the common voltage.

3. The method according to claim 2, wherein the positive blanking data voltage is greater than the common voltage, and the negative blanking data voltage is less than the common voltage.

4. The method according to claim 3, wherein the absolute difference value between the positive blanking data voltage and the common voltage is substantially equal to the absolute difference value between the negative blanking data voltage and the common voltage.

5. The method according to claim 3, wherein in any two adjacent data lines, when a data voltage of one data line is positive relative to the common voltage, a corresponding blanking data voltage is the positive blanking data voltage, a data voltage of the other data line is negative relative to the common voltage, and a corresponding blanking data voltage is the negative blanking data voltage.

6. A driving circuit, adapted to drive a display panel that has a plurality of data lines and at least one common electrode line, the driving circuit comprising:
a blanking interval detector, configured to generate a selection signal, wherein the selection signal is configured to indicate an active interval or a vertical blanking interval;
a source driver, electrically connected to the plurality of data lines; and
a first multiplexer, electrically connected to the source driver and the blanking interval detector, wherein the first multiplexer is configured to control, according to the selection signal, the source driver to selectively provide a data voltage or a blanking data voltage to the source driver.

7. The driving circuit according to claim 6, wherein the source driver converts a data signal into a corresponding drive data voltage according to a polarity signal and a reference voltage that is received from the first multiplexer, wherein the first multiplexer comprises a plurality of sub-multiplexers, each of the plurality of sub-multiplexers of the first multiplexer comprising:
a first input terminal, electrically connected to a corresponding data reference voltage source;
a second input terminal, electrically connected to a corresponding blanking reference voltage source;
a selection terminal, configured to receive the selection signal; and
an output terminal, electrically connected to the source driver, wherein when the selection signal indicates the active interval, the first input terminal is conducted to the source driver, and when the selection signal indicates the vertical blanking interval, the second input terminal is conducted to the source driver.

8. The driving circuit according to claim 7, wherein the corresponding data reference voltage source is different from the corresponding blanking reference voltage source.

9. The driving circuit according to claim 6, wherein the first multiplexer comprises:
a first input terminal, configured to receive a data signal;
a second input terminal, configured to receive a blanking drive signal;
a selection terminal, configured to receive the selection signal; and
an output terminal, electrically connected to the source driver, wherein when the selection signal indicates the active interval, the output terminal is configured to output a data drive signal to the source driver according to the data signal, and when the selection signal indicates the vertical blanking interval, the output terminal is configured to output a positive blanking drive signal or a negative blanking drive signal to the source driver according to the blanking drive signal.

10. The driving circuit according to claim 9, further comprising a second multiplexer, wherein the second multiplexer comprises:
a first input terminal, configured to receive the positive blanking drive signal;
a second input terminal, configured to receive the negative blanking drive signal;
a selection terminal, configured to receive a polarity signal; and
an output terminal, electrically connected to the second input terminal of the first multiplexer, wherein when the polarity signal indicates positive, the output terminal is configured to output the positive blanking drive signal to the first multiplexer, and when the polarity signal indicates negative, the output terminal is configured to output the negative blanking drive signal to the first multiplexer.
